(19) United States
(12) Patent Application Publication
(10) Pub. No.: US 2012/0100519 A1
(43) Pub. Date: Apr. 26, 2012

(54) TRAINING SYSTEM

(75) Inventors: Timo-Pekka LEINONEN, Tampere (FI); Anu LEINONEN, Tampere (FI)

(73) Assignee: VOCTRAINER OY, Tampere (FI)

(21) Appl. No.: 12/908,999

(22) Filed: Oct. 21, 2010

(51) Int. Cl. G09B 7/00

(52) U.S. Cl. 434/350; 434/362

(57) ABSTRACT

A method for training involves maintaining a plurality of details to be tested; maintaining group definitions which define a plurality of groups associated with two or more of the details; determining a test detail; outputting to a user a question to which the test detail is a correct answer; inputting from the user an answer to the question; determining whether the answer comprises more than one parts. If yes: determining other details belonging to a common group with the test detail; determining which if any of the test detail and of the other details match the parts of the answer and considering such details as correctly answered details; and storing for each correctly answered detail an indication of a correct answer. If the answer comprises no more than one part, then: determining if the answer correctly matches the test detail; and if yes, storing an indication of a correct answer.

### BACKGROUND

1. Field

The present invention generally relates to a training system.

2. Brief Description of Related Developments

In the present computer-based teaching systems details are usually tested one by one. In another alternative, certain number of detail level tests are used to estimate the knowledge of a student with certain probability. For example, if a student answers all the following tests correctly: 1*4=4, 2*4=8, 3*4=12 and 5*4=20, it is likely with certain probability that she would also know the result of test: 4*4=12. However, the only way to ensure determining of the level of knowledge is testing all details one by one. Unfortunately, from the student's point of view, such testing may appear boring and time-consuming. Slower progress in the training further translates into higher demand of computing resources and energy in comparison to speedier training processes.

### SUMMARY

According to a first aspect of the disclosed embodiments there is provided a method comprising:

maintaining a plurality of details to be tested;

maintaining group definitions which define a plurality of groups each of which groups is associated with two or more of the details;

determining a detail to be tested that is a test detail;

outputting to a user a question to which the test detail is a correct answer;

inputting from the user an answer to the question;

determining whether the answer comprises more than one parts and if yes, then:
determining other details belonging to a common group with the test detail;
determining which if any of the test detail and of the other details match the parts of the answer and considering such details as correctly answered details; and
storing for each correctly answered detail an indication of a correct answer;

and if the answer comprises no more than one part, then:
determining if the answer correctly matches the test detail; and
if yes, storing for the test detail an indication of a correct answer.

The method may further comprise indicating to the user any correct answers input from the user.

According to a second aspect of the disclosed embodiments there is provided an apparatus comprising:

a memory configured to maintain a plurality of details to be tested and to maintain group definitions which define a plurality of groups each of which groups is associated with two or more of the details;

a processor configured to determine a detail to be tested that is a test detail;

an output configured to output to a user a question to which the test detail is a correct answer;

an input configured to input from the user an answer to the question;

the processor being further configured to:
determining whether the answer comprises more than one parts and if yes, then:
   determining other details belonging to a common group with the test detail;
   determining which if any of the test detail and of the other details match the parts of the answer and considering such details as correctly answered details; and
   storing in the memory for each correctly answered detail an indication of a correct answer;
and if the answer comprises no more than one part, then:
   determining if the answer correctly matches the test detail; and
   if yes, storing for the test detail an indication of a correct answer.

The memory may consist of one or more structurally and/or functionally separate memory units.

The processor may consist of one or more structurally and/or functionally separate processing units.

The input may comprise a user interface.

The user interface may consist of one or more structurally and/or functionally separate user interface elements.

The different parts may be detected from the presence of a given delimiter. The given delimiter may be predetermined. The given delimiter may be selected from a group consisting of a comma, semicolon, space, tabulator, slash and dash.

The memory may be configured to maintain a score corresponding to different details. The processor may be further configured to base the determining of the detail to be tested on the score.

The processor may be further configured to modify the score indicative of a correct answer for each correctly answered detail only if the answer comprised only correctly answered details.

Alternatively, the processor may be further configured to modify the score indicative of a correct answer for each correctly answered detail regardless whether the answer comprised only correctly answered details.

The processor may be further configured to modify the score indicative of a correct answer for each correctly answered detail only if the correctly answered details were provided in the answer in a correct order. Alternatively, the processor may be further configured to modify the score indicative of a correct answer for each correctly answered detail regardless whether the correctly answered details were provided in the answer in a correct order.

The processor may be further configured to modify the manner of modifying the score indicative of correct answers depending on one criterion or more than one criterion. The criterion or criteria may involve any one or more of the following: potential safety consequences resulting from errors in learning; set learning target; number of details being tested; and user preference.

The apparatus may comprise a network terminal. The apparatus may be accessed by a web browser. Alternatively, a client station may be configured to operate as the apparatus. The client station may be a fixed or mobile processing unit such as a personal computer, game console, laptop computer, personal digital assistant device, navigation device, mobile telephone, and/or portable internet browser.

According to a third aspect of the disclosed embodiments there is provided a computer program comprising computer executable program code configured to perform, when executed by a computer, the method of the first aspect.

The computer program may be stored in a computer readable memory medium.

According to a fourth aspect of the disclosed embodiments there is provided an apparatus comprising:

a memory comprising a learning database and a user database;

the learning database comprising a set of details to be learned;

the user database comprising a user profile, the user profile comprising a weighing vector of weighing parameters corresponding to the set of details; and

a processor configured to test a user for particular details in an order that is at least partly based on the weighing parameters;

wherein the processor is further configured to adjust the weighing parameter corresponding to a given detail depending on whether the user has passed the test.

The apparatus is preferably a network server. Alternatively, the apparatus is a user device.

Advantageously, small computational cost and memory requirement is imposed by maintaining weighing vectors of weighing parameters for different users so that the weighing vectors correspond to details in the learning database.

The processor may be configured to select the particular detail by choosing details in defined sets which consist of details of predetermined range of weighing parameters.

The predetermined range may comprise any one or more of the following four subsets:
a first subset of details the testing of which the user has passed;
a second subset of details that the user has passed on the latest test but not on the immediately preceding test;
a third subset of details the testing of which the user has not passed on the latest test and the user has attempted that test at least once before;
a fourth subset of details the testing of which the user has not attempted.

The predetermined range may be balanced such that if there are sufficiently many details in the respective subsets, the predetermined range contains a first proportion details of the first subset, a second proportion of details of the second subset, a third proportion of details of the third subset and a fourth proportion of details of the fourth subset.

Advantageously, when learning of the user progresses, the details may be shifted by the processor from the one subset to a preceding subset (e.g. from the second subset to the first subset). Advantageously the shifting may enhance learning efficiency by attempting to maintain a predetermined mix of details being tested.

The processor may be configured to initially set the weighing parameters to an initial value. Each time the user passes the test of the detail, the processor may increase the weighing parameter towards a predetermined maximum. Each time the user fails in the test of the detail, the processor may decrease the weighing parameter towards a predetermined minimum. The predetermined minimum may be larger than the initial value. Alternatively, the predetermined minimum may be smaller than or equal to the initial value.

The user profile may also comprise time vector comprising for each detail a time stamp indicative of the latest time the detail has been tested.

The details may be stored in the learning database in an order corresponding to relative priority of the details for learning. The order may be ascending or descending. Alternatively, the learning database may further comprise priority factors associated with some or all of the details for selecting subsets of the details making use of the priority factors.

The processor may be further configured to account for the time stamps so as to maintain a minimum interval between two tests concerning a common detail. The timestamps may increase the likelihood that the details are recalled from a long term memory of the user so as to enhance permanent learning. Moreover, this may increase the number of different details the testing of which is repeated during a learning day increasing the variance of the learning and making the learning thus more motivating.

The details may comprise details of a human language. The details may comprise any of the following: words of vocabulary of the language; grammar rules and exceptions of grammar rules including any classification; expressions; typical sentences; idiomatic expressions; abbreviations; conjugations of aforementioned details; proper context to use for any of the aforementioned details.

The apparatus may further comprise a speech synthesizer. Alternatively, or additionally, the details may be stored in spoken form.

The apparatus may be configured to present details in a tone indicative of the type of the details. The type may be the article of nouns.

The fourth aspect may be combined with the second aspect of the disclosed embodiments.

According to a fifth aspect of the disclosed embodiments there is provided a method comprising:

accessing a learning database comprising a set of details to be learned;

accessing a user database comprising a user profile, the user profile comprising a weighing vector of weighing parameters corresponding to the set of details;

testing a user for particular details in an order that is at least partly based on the weighing parameters; and

adjusting the weighing parameter corresponding to a given detail depending on whether the user has passed the test.

The fifth aspect may be combined with the first aspect.

According to a sixth aspect of the disclosed embodiments there is provided a computer program comprising:

computer executable program code configured to enable a computer to access a learning database comprising a set of details to be learned;

computer executable program code configured to enable a computer to access a user database comprising a user profile, the user profile comprising a weighing vector of weighing parameters corresponding to the set of details;

computer executable program code configured to enable a computer to test a user for particular details in an order that is at least partly based on the weighing parameters; and

computer executable program code configured to enable a computer to adjust the weighing parameter corresponding to a given detail depending on whether the user has passed the test.

The sixth aspect may be combined with the third aspect.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present disclosure have been illustrated in the foregoing. The above embodiments are used merely to explain selected aspects or steps that may be utilized in implementations of the present disclosure. Some embodiments may be presented only with reference to certain example aspects of the present disclosure. It should be appreciated that corresponding embodiments may apply to other example aspects as well.

### BRIEF DESCRIPTION OF THE DRAWINGS

The aspects of the disclosed embodiments will be described, by way of example only, with reference to the accompanying drawings, in which:

FIG. 1 shows a schematic picture of a system incorporating aspects of the disclosed embodiments;

FIG. 2 shows a block diagram of a server incorporating aspects of the disclosed embodiments;

FIG. 3 shows a flow chart of a process according to an embodiment of the disclosure;

FIG. 4 illustrates test results achieved by using the process described with reference to FIG. 3 where a native Finnish speaker started studying Spanish;

FIG. 5 illustrates a learning database suited for use in the system of FIG. 1;

FIG. 6 illustrates a user database suited for use in the system of FIG. 1; and

FIG. 7 shows a schematic drawing of a process according to an embodiment related to identifying of further answers.

### DETAILED DESCRIPTION OF THE DISCLOSED EMBODIMENTS

In the following description, like reference signs denote like elements.

Learning of details of a foreign language may be significantly accelerated if the learning process i.e. repetition of the details is optimized according to the individual learner's detail specific learning history. There is a need for a simple, lightweight process to teach these details in the optimal order and repetition frequency in order to arrange the learning using a network server that is easily accessible with common web browsers. Moreover, there is a need to make entry of different details fluent and simple. Preferably, the learner should also be able to enter associated other details (such as different forms of asked word) together with the requested answer.

### Description of Learning Adaptation Related Embodiments

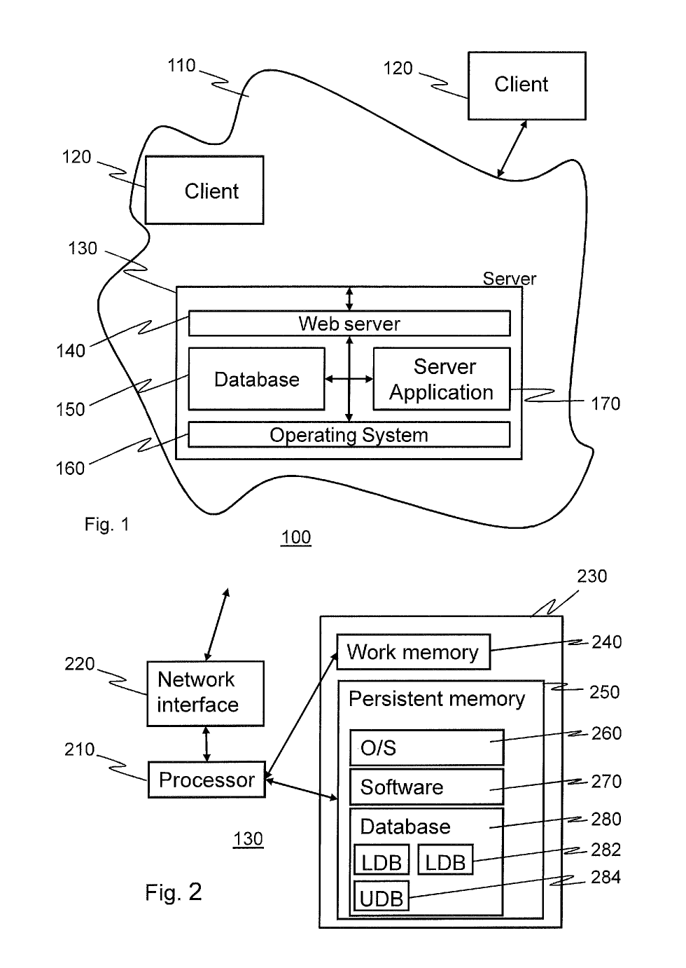

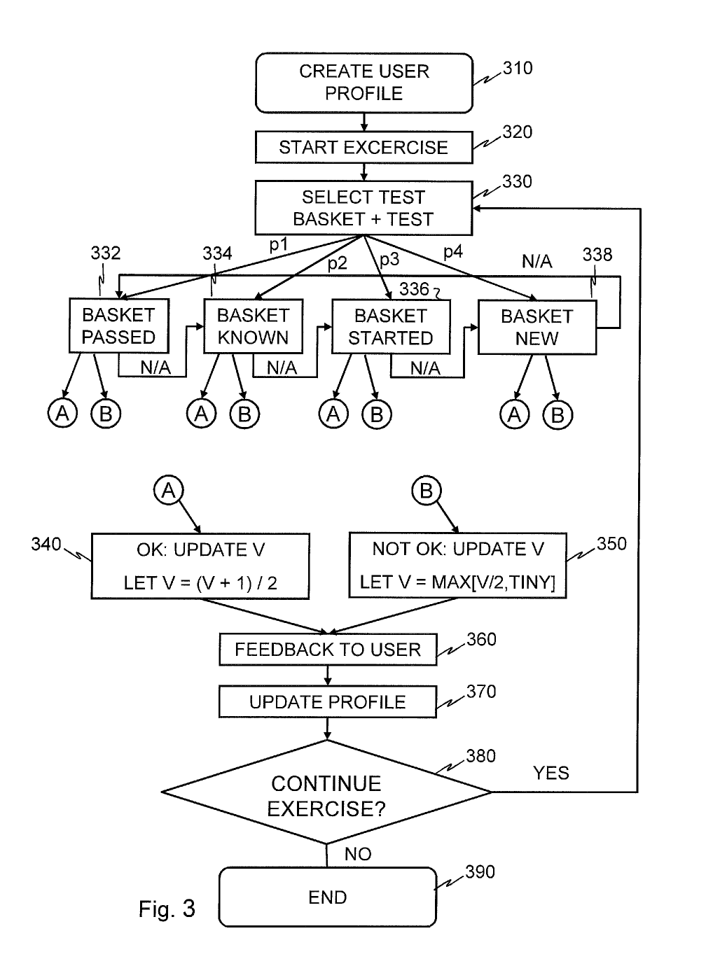

FIG. 1 shows a schematic picture of a system 100 according to an aspect of the disclosed embodiments. The system 100 comprises a data network 110 such as the Internet that provides access for a plurality of clients 120 to a server 130. The server 130 comprises a web server 140 that provides Internet browser based access to the server 130, a database 150, operating system 160 and server application 170 that controls the operation of the server e.g. according to the process illustrated by FIG. 3. The server 130 is provided for functional description of an example network entity for using some aspects of the disclosed embodiments. It is appreciated that the implementation of the server 130 may be widely varied, e.g. the database 150 may be distributed to a discrete database server. Moreover, the server 130 may be implemented using cluster technology so that a common server computer may implement the server 130 among other functions.

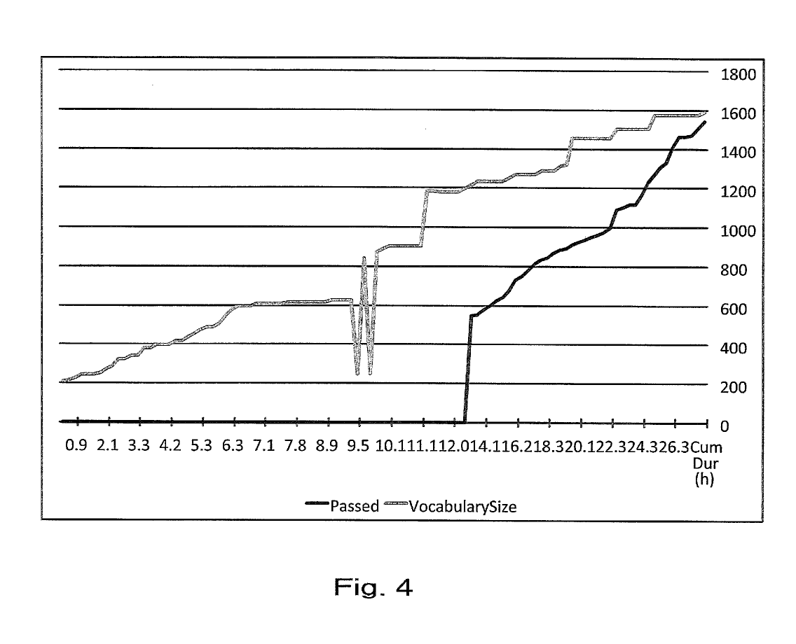

FIG. 2 shows a block diagram of the server 130 according to an aspect of the disclosed embodiments. The server comprises a processor 210 for controlling various parts of the server, a network interface 220 for data exchange with other network entities (with clients and optionally with other servers) and a memory 230. The memory 230 comprises a work memory 240 such as a random access memory in which the processor may execute different programs or computer executable program code that controls with the processor the operation of the server 130. The memory 230 further comprises a persistent memory 250 that comprises an operating system 260 for controlling the use of resources of the server 130, software 270 such as the computer program code defining the web server 140 and server application 170, and a database 280. The database 280 practically involves two or more different databases, i.e. there are one or more different learning databases (LDB) 282 containing e.g. questions and answers related to grammar and/or vocabulary of a foreign language. The questions may be formed, for instance, so that they comprise three parts: a question text (Q₁ to Q_{N} in FIG. 4), answer type indicator (e.g. number, selection indication such as “a, b, c or d”, free text, Qt₁ to Qt_{N} in FIG. 4), and criteria for correct answer (e.g. correct selection indication or alternative answer texts with optional tolerance coefficient, A₁ to A_{N} 420 in FIG. 4). For instance, one question may be vocabulary-related “Cat in German? (text)” to which the user should write as an answer “die Katze”. Some tolerance may be provided so that e.g. one letter error is accepted as a passed test, while then the deviation is e.g. automatically corrected so that the user would learn also the correct form. The correct answer may comprise one or more data fields. For instance, German nouns have three articles which may be defined simply with two bits (one of the four combinations indicative of that the word is not a noun and other three for the corresponding options, “der”, “die”, or “das”). The databases 280 also involve a user database 284, which typically comprises user's login details such as Login ID 610 and password 620 (FIG. 6), name 630 (FIG. 6), subject or topic for exercise 640 (FIG. 6), use history 650 (FIG. 6), learning objectives 660 (FIG. 6) and also one or more vectors of parameters (e.g. weighing parameters 670 and time stamps 680) as will be explained with further detail.

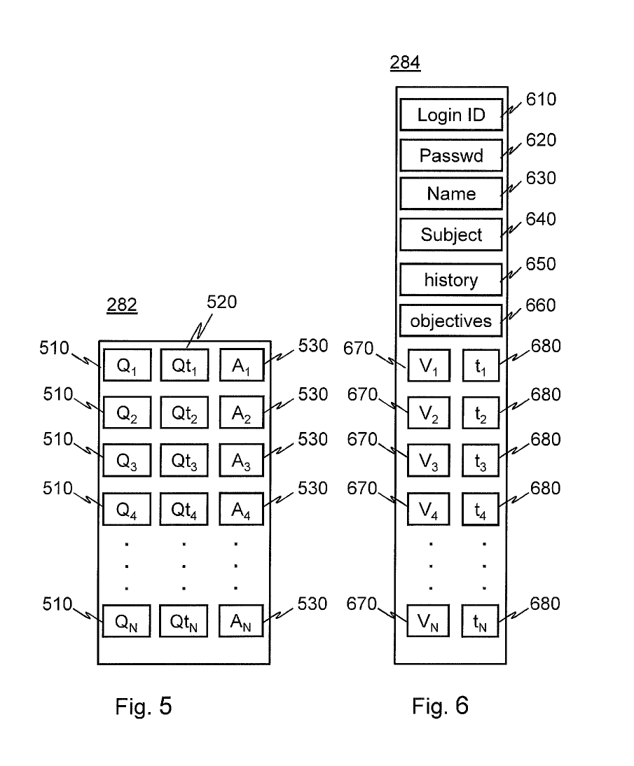

It is seen as a pre-requisite for the process described with reference to FIG. 3 that the details (e.g. questions and answers in FIG. 5) are organized into descending priority order according to the importance of learning those details in general, for a specific user group e.g. restaurant workers or business travelers, or for an individual user based on her specific learning targets. Alternatively, the details are organized in another order (e.g. alphabetically) and the details are associated with relative priority factors for selecting details in a meaningful order. In the following, it is assumed that the learning database is in the descending priority order.

The learning database may be common to a group of learners (e.g. based on a given level in the language being studied) or the learning database may be tailored to a specific learner and her targeted usage of the language to be learned. In any case, the starting point is that there is a learning database LDB 282 that remains unchanged through the exercise session. Only weighing parameters and optionally time stamps are being updated in the user's profile in course of an exercise and through a training program as a whole. There should be no need to rearrange an entire user dictionary and also typically users may share a common dictionary so that the user profiles can be kept very compact and thus computationally light.

The weighing parameters 670 can be seen as a representation of the user's learning history of a detail. The process of FIG. 3 can indeed express not only the latest test result or trial result but also the result of earlier tests so that the process can be seen as a particularly powerful one and even more so for the use in network servers where a single server may be needed for a vast number of clients.

FIG. 3 shows a flow chart of a process according to an aspect of the disclosed embodiments. The process starts from step 310, in which the server 130 is up and running and the server creates a new user profile. Typically, this step involves assigning a new user with login credentials and initializing parameters stored for the user. Advantageously, each user has a vector of weighing parameters (i.e. a weighing vector formed of the weighing parameters 670) and optionally another vector of time stamps 680. The weighing parameters 670 correspond to details or to questions and answers 510,520,530 of the learning database 282. In the particularly described method, the weighing parameters 670 are first initialized to zero value. This method is next described assuming that the weighing parameters are floating point numbers. However, in practical implementation, the weighing parameter can be represented e.g. as a five or seven bit number ranging between 0 and 1 so as to reduce memory requirements, while the weighing parameter is translated in use to a number in this range. Moreover, it is appreciated that the described embodiment is but one example on how a network based server can computationally efficiently serve numerous clients (e.g. thousands of simultaneous sessions) with economically reasonable computational resources.

Once the user desires to start practicing with the learning system, a learning session is started 320. In a single learning session, details (or questions) are presented to the learner in relatively small sets (e.g. N=5, N=10 or N=20). Testing if the learner knows a given detail is called a try, and going through one set of details (a set of tries) is called an exercise.

After the user starts an exercise, a test basket is selected 330 for selecting a test of a particular type. At this step, the user is provided with varying of the types of the questions so that:
desired first proportion p1 of the questions relates to details that has been correctly answered by the user for several consecutive tries in a row (basket passed, 332),
desired second proportion p2 of the questions relates to details that were known last time, but not in the try before that (basket known, 334),
desired third proportion p3 of the questions relates to details that were answered wrong on latest try (basket started, 336),
desired fourth proportion p4 of the questions relates to details that have not yet been tested (basket new, 338),

The baskets known, started and new collectively form an exercise basket of details or tests to be exercised. Furthermore, the passed details are also being exercised to an extent that is useful for maintenance of the learning of those details.

The test basket selection may be based, for instance, by randomly selecting a number from a range that is split into sub-ranges in proportion to the previously described proportions (first to fourth proportion). If there are no details in the selected basket, the selection should advance to following basket in the order these baskets were described in the foregoing and as illustrated by FIG. 3.

When the basket “new” becomes empty i.e. the learning of all the details has started, the selection should advance to any details based to the ascending order of the value v. In practice, this means selecting any details starting with those with the lowest level of knowledge. This, with the above described advance of the selection to the following basket, leads to a situation where in the end all the details are in the passed basket i.e. permanently learned. However, the training may still continue, and the training may further automatically shift to maintaining the achieved level of knowledge focusing on those details with the lowest level of knowledge including the passed details.

Let us next describe how the details are categorized into the different test baskets. First, let still stress that the innovation can be modified to work using integers, fraction numbers, floating point numbers, or any other numeric type or range, but is presented here using floating point numbers having range from 0.0 to 1.0.

First Exercise

1. Before starting, the weighing parameter v of each floating point number is initialized to zero (0.0).
2. Details are selected to an exercise in priority order. As there is no learning history at the beginning, the first exercise will consist of the N first details that also correspond to N highest priority details (as the details are listed in descending order of priority).
3. Details are presented to the user e.g. one by one using appropriate hints such as picture, video, sound, scent, description, definition, synonyms, antonyms, other hints. The weighing parameter representing the learning history of this detail is updated based on the result of the try as follows:

If the result is positive i.e. the detail was known, the process advances to branch (A) in step 340 and the weighing parameter is updated according to equation (1):

Let v=(v+1.0)/2.0 (1)

If the result is negative i.e. the detail was not known, the process advances to branch (B) in step 350 and the weighing parameter is updated according to equation (2):

Let v=MAX(v/2.0,TINY) (2)

In equations (1) and (2), v is given a new value based on its previous value. TINY is a predefined constant that represents a small numeric value e.g. 0.0001.

Advantageously, by setting v to TINY in situations where v would otherwise get value zero, the tested detail is distinguishable from other details that have never been tried.

The classification of a detail in the various baskets follows the following rules:

PASSED i.e. known several consecutive tries in row and therefore considered as permanently learned. This is done by searching vector for values where

v≧0.75 known last 2 times

v≧0.875 known last 3 times

v≧0.9375 known last 4 times
etc.

The threshold value for v in the foregoing (0.75, 0.875, 0.9375, . . . ) is also referred to as passed threshold that may be generally be defined, based on a number M of required consecutive positive tries: Passed threshold=1−(½)^{M}

KNOWN i.e. known last time, but not in the try before that
0.5≦v<passed threshold (e.g. 0.75)

STARTED i.e. tried but answered wrong during the last try
0.0≦v≦0.5

NEW i.e. never tried
v=0.0

It is apparent from the classification example that the single weighing parameter is capable of maintaining the state of corresponding detail's learning and of ordering the details in a feasible manner so as to enhance learning by focusing attention on where it helps the learner the most.

The user is provided with feedback in step 360 to provide the user with appropriate positive or negative feedback depending on the answer to the latest test.

The user's profile is updated 370 according to the outcome of the test. The updating may alternatively be arranged before providing the feedback to the user; that order may be particularly useful e.g. to avoid changing the outcome by simply closing the session.

It is next checked 380 whether the exercise is continued. This checking may involve whether there are remaining details in the exercise basket. Moreover, if the exercise basket has exhausted, the user may be prompted for a new exercise. If the exercise is to be continued, the process resumes to step 330. If a new exercise is to be started, the process resumes to step 320. If the exercising is to end, the process terminates at step 390.

### Time

The algorithm described in the foregoing is further enhanced in one embodiment by saving for each detail in addition to the weighing parameter v a learner specific time stamp in the time vector to indicate the time of the last try of that detail. Using this time stamp the processor may maintain a minimum interval (e.g. 24 hours, one night or one hour) between the repetitions of a given detail. This increases the number of different details repeated during a learning day, and ensures that especially the known and passed details have been memorized deeply and not only on surface level.

### Test Results

In the test made using English, French, German, Japanese, Russian, Spanish and Swedish as foreign languages this algorithm proven to significantly increase the learning speed of a foreign language regardless of the language in questions i.e. the aspects of the disclosed embodiments are probably applicable to all languages, including mother tongue for students with learning difficulties.

FIG. 4 illustrates test results achieved by using the process described with reference to FIG. 3 where a native Finnish speaker started studying Spanish. FIG. 4 charts the amount of different details (vocabulary size in the chart) and the number of passed details as a function of cumulative exercise time. The vocabulary size describes the starting of new details. That is, initially there are about 200 details in the started and known baskets together, and as the training proceeds, details are shifted based on the result of the test from new basket to the started basket (negative results) and known basket (positive result). Details in these two baskets are then tested frequently based on the aforementioned process until the detail specific value v reaches the passed threshold and the detail moves to the passed basked (passed in the chart).

Around 9.5 hours of cumulative exercising, considerable decrease of the size of the started and known baskets was tested without significant noticed impact to the learning speed.

Details have been shifted to the passed basket since the beginning of the trial based on the passed threshold. Unfortunately, collecting of statistical information about this shifting rate was started only after 12 cumulative exercise hours. However, based on the described algorithm, the shifting rate of details to the passed basked can be safely assumed to have started relatively slowly due to the required number of detail specific consecutive positive tests, accelerating then towards 12 hours and after that milestone. This, however, does not impact an important finding that resulted from the trial: out of 1588 new details, 1541 (97%) were permanently learned in 27.1 hours. This knowledge was proven through several consecutive positive tests with at least 24 h interval. Moreover, the test was conducted with strict spelling criteria, that is, without any tolerance for any wrong capitalization, extra blanks or corresponding deviations. Anything else but exact string match was considered as a negative test result. Only character by character complete match qualified as a positive test result. Therefore, at least a considerable part of the remaining 3% of the details below the passed threshold are considered to be so classified rather due to erroneous typing and other simple mistakes rather than errors in learning. On average, outcome translates into learning of 56.8 details per hour.

For this student, who normally needs several hundred hours of effort in order to learn 1500 details of a new language using traditional methods, the learning efficiency improvement was significant. In addition, the learning was experienced more motivating due to optimized and variable repetition order of the details.

Assuming this kind of learning speed, and e.g. that the learned details of a language are the most important words of its vocabulary, a vocabulary of 2 000 words can be assumed to be learned during less than 40 hours of effort (2 000 details/40 h=50 details/h). Especially as the learning typically accelerates as function of time due to the learner becoming more familiar with the spelling, forming of associations with other languages and other typical characteristics of the language being learned.

Depending on the language and reference, 2 000 most frequent words typically cover 95% of the normally used language. This in turn means that with cumulative effort corresponding to the hours of a working week, it is possible to learn vocabulary that enables fluent usage of a language including reading, writing, speaking and listening. This, in addition to being a valuable achievement itself and a typical target of year long language courses, enables further learning of a language on natural basis. If there is a concept or word that the learner is not familiar with, She is able to ask about it, and able to understand the received explanation. She is also able to understand meaning of written or heard words based on their context and surrounding words, and able to use monolingual dictionaries.

Details of a foreign language include but are not limited to

1. words of its vocabulary
2. grammar rules and exceptions including any classification
3. expressions and typical sentences
4. abbreviations
5. conjugation of those details
6. proper context to use those details

Another embodiment provides help with learning the articles of nouns by means of technical facilities. Namely, it is known that one particularly difficult area in the learning of a foreign language is to learn the articles of nouns e.g. der-die-das of German, el-la of Spanish, le-la of French, en-ett of Swedish etc. It is realised that this problem can be eased making use of neurologically different cognition of different tones or voices so as to direct stimulus to different parts of human brain and help to establish an association between nouns and their articles. This mechanism is one likely possibility and explains the measured effect of this method. In this example, the processor is configured to audibly express different nouns using voices of different persons in order to facilitate the learning of the genders of the nouns. For example, a man's voice is used to pronounce all Swedish “en” nouns, a female voice for all Swedish “ett” nouns. This method may also be referred to as acoustic distinguishing of articles or other grammatical features. Thanks to the method, it has been noticed that the learning becomes faster and easier for either consciously or unconsciously to separate and know the articles of the nouns of the studied language.

### Description of Embodiments Related to Identifying of Further Answers

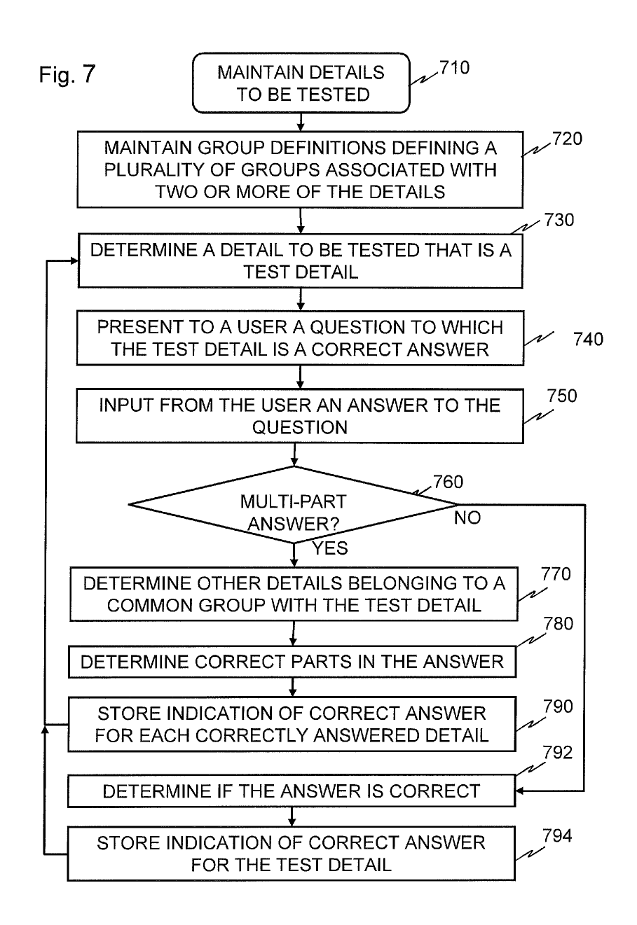

The hardware and service platforms described in the foregoing may also be applied with these embodiments. However, it is not necessary to implement all features described or shown in Figures related to the foregoing description. For instance, the weighing parameters need not be implemented in these embodiments. For illustrating some main features of the following description, reference is made to FIG. 7 that shows a schematic drawing of a process according to an embodiment related to identifying of further answers.

In one example that illustrates some aspects related to these embodiments, it may be considered that there are various details that are logically associated with one or more other details. Step 710 shows maintaining a plurality of details to be tested and Step 720 shows maintaining group definitions which define a plurality of groups each of which groups is associated with two or more of the details. When asking for one detail from such a group of logically associated details, the user may wish to also provide remaining details of that group in response to a question enquiring one specific detail. For instance, when asked for a verb, the user may realise that the verb in question is irregular one and also provide the past tenses of that verb (such as seek-sought-sought).

Now, let us consider computer based learning systems where the knowledge of a student is tested on study item level (e.g. a detail of a language (e.g. a word, for example, “cat”) or a value of a multiplication table (e.g. “3*4=12”) and the results of those tests are stored. The storage can take place on detail level (e.g. “student knew that 3 times 4 equals to 12”), on summary level (“student knew the multiplication table of 4 from 1 to 10 with 80% level of correctness”), on even higher summary level (“student is good in arithmetic”) or on several levels.

Details of a language include but are not limited to

1. words of vocabulary of the language

2. grammar rules and exceptions including any classification

3. expressions and typical sentences

4. abbreviations

5. conjugation of those details

6. proper context to use those details

Real life details are often related to each other. The nature of this relation largely varies, but is often known and commonly understood by teachers and students of a specific domain. For example, the following details of a domain are related to each other according to a commonly known but different relation:
A. Irregular English verb tenses: present-imperfect-past participle. E.g.: do-did-done.
B. Words with a common body. For example, the English noun-verb-adjective-adverb combinations. E.g.: a conflict- to conflict-conflicting-conflictingly.
C. Conjugation of verbs. E.g., the present singular and plural subjunctive forms of Spanish verb deber: deba-debas-deba-debamos-debáis-deban
D. Multiplication table. E.g. multiplication table of 4 from 0 to 5: 0-4-8-12-16-20.
E. Parts of a word. For example, the Japanese word chikatetsu ( [symbol] =subway, metro) is composed of three kanji characters: chi ( [symbol] ), ka ( [symbol] ) and tetsu ( [symbol] ).

On asking the user for any particular detail, it is determined 730 which detail is to be tested that is a test detail and the user is presented 740 with a user a question to which the test detail is a correct answer. An answer is input 750 from the user to the question. A sequence answer is accepted as correct answer to a test in alternative to the traditional answer containing only answer to the specific test. Such a sequence answer may contain optional further parts in addition to an expected one. If the sequence contains correct answers to several detail tests, a positive test results is recorded for those. In other words, if a student figures out the nature of a sequence related to the detail being asked and so desires, she may answer several tests together.

In one embodiment, the process continues after step 750 by:

determining 760 whether the answer comprises more than one parts and if yes, then:
determining 770 other details belonging to a common group with the test detail;
determining 780 which if any of the test detail and of the other details match the parts of the answer and considering such details as correctly answered details; and
storing 790 for each correctly answered detail an indication of a correct answer and resume to step 730 if further questions are to be presented;

and if the answer comprises no more than one part, then:
determining 792 if the answer correctly matches the test detail; and
if yes, storing 794 for the test detail an indication of a correct answer

and resume to step 730 if further questions are to be presented.

### EXAMPLES

A. A student is learning the conjugation of irregular English verbs and is tested for the imperfect of the verb do. She figures out the pattern and answers: “do did done”.
As the consequence of this correct sequence answer, the student gets positive result for the following detailed test
   I. Present tense of do (“do”).
   II. Imperfect tense of do (“did”).
   III. Past participle tense of do (“done”).
B. A student is learning English words and is tested for the detail “to conflict” (here, the preposition “to” identifies a verb). She answers: “to conflict conflictingly”
As the consequence, the student gets positive results for the following detailed tests
   I. Verb “to conflict”.
   II. Adverb “conflictingly”.
C. A student is learning conjugation of Spanish verbs and is tested for singular II present subjunctive form of verb deber. She answers: “deba-debas-deba-debamos-debáis-deban
As the consequence, the student gets positive results for the following detailed tests:
   I. Verb “deber”, subjunctive, singular I (“deba”).
   II. Verb “deber”, subjunctive, singular II (“debas”).
   III. Verb “deber”, subjunctive, singular III (“deba”).
   IV. Verb “deber”, subjunctive, plural I (“debamos”).
   V. Verb “deber”, subjunctive, plural II (“debáis”).
   VI. Verb “deber”, subjunctive, plural III (“deban”).
D. A student is learning the multiplication table of 4 and is tested for 3 times 4. She answers: 0-4-8-12-16-20. As the consequence, the student gets positive results for the following detailed tests:
   I. 0*4=0
   II. 1*4=4
   III. 2*4=8
   IV. 3*4=12
   V. 4*4=16
   VI. 5*4=20
E. As student is learning Japanese kanji characters and is tested for the first character of the word chikatetsu ( [symbol] , chi). She answers: “ [symbol] ”. As the consequence, the student gets positive results for the following detailed tests: Kanji character “chi” in connection to the word “chikatetsu” ( [symbol] ). Kanji character “ka” in connection to the word “chikatetsu” ( [symbol] ). Kanji character “tetsu” in connection to the word “chikatetsu ( [symbol] ).

In each of the preceding examples, it may be understood that the sought detail belongs to a group of associated details. By providing further, so-called sequential details, the user may answer also to questions not yet asked and thus show her knowledge of these details. This reduces the number of different questions needed and lets the user answer to the questions with the series of answers that anyway are linked as one group in the mind of the user, thus making the exercising and learning more intuitive.

There are several ways to interpret and score the sequence answers that contain correct tests for certain details but not exactly correct answers to the tests of all related details.

In one embodiment, a correct answer indication is recorded to any related detail when a sequence answer is given only if the sequence answer contains exactly correct answer to every associated detail and they are in exactly correct order.

For example, anything else than “do did done” is interpreted as wrong sequence answer and no credit is given when imperfect tense of do is tested (excluding the traditional answer “did” that naturally gives normal score for that detailed test).

In another embodiment, correct answer is recorded for any related detail that is included into a sequence answer regardless of the order of the answers.

For example, a student answers “do done” when tested for the imperfect tense of do and is given positive test result for the present and past participle tenses of do. This embodiment may also be applied when one of the associated details was already revealed in the question so as to avoid need for the user to type or otherwise enter the detail that is readily provided by the question itself. Using the example “do done”, in this particular case there would be no need to enter “did” as it was already in the question and thus “do done” would be considered as a correct answer for the two details “do” and “done”.

In another preferred embodiment, correct answer is recorded for any related detail that is included into a sequence answer but only if the correct answer to the actually tested detail is among those.

For example, a student answers “do done” when tested for the imperfect tense of do and is not given any positive test results.

In yet another preferred embodiment, correct answer is recorded for any related detail that is included into a sequence answer without any other limitations.

For example, a student answers “do zyx done bb” when tested for the imperfect tense of do and is given positive test result for the present and past participle tenses of do.

As seen above, there are numerous alternatives as to how to interpret a sequence answer. The interpretation of a sequence answer may be adapted or optimized according to the learned details, according to the people forming the group of students and according to the purpose of study. For example, if the target is to achieve a commercial aircraft pilot license, the interpretation of sequence answers shall be very strict and if the target is to learn a few words of a foreign language in order to participate a guided tour for retired persons, the interpretation of sequence answers can be rather relaxed.

By approving sequence answers, various advantages may be attained over the current learning systems, such as:
Learning is more motivating, when several known tests can be answered at the same time.
The students are motivated to study the related details and the relationship between these details that will also deepen their understanding, accelerating thus the learning process and helping to recall the learned details better (any additional connection, for example, a relationship helps to recall a detail better).
Sequence answers enable using the same system for wider student audience. The more advanced students can give sequence answers and at the same time the other students can continue using the same system focusing on the detailed tests. This also enables presenting of the question by a human presenter.
Transition from the current level of learning can be shifted to a more advanced level in a natural and smooth manner by starting to give sequence answers when applicable detail by detail. At the beginning very seldom but later more and more often.
Computing resources are saved when one test can give answers to several related test cases.
Network traffic is reduced when instead of transferring several test cases the transfer of a test case can give answers to several related test cases.
Energy consumption and thus the generation of heat and waste is reduced when less computing resources are needed.
Learning is more efficient when the speed of answering is increased, as the learner may strengthen memorizing of associated groups of details.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the scope and spirit of the appended patent claims.

What is claimed is:

1. A method comprising:
maintaining a plurality of details to be tested;
maintaining group definitions which define a plurality of groups each of which groups is associated with two or more of the details;
determining a detail to be tested that is a test detail;
outputting to a user a question to which the test detail is a correct answer;
inputting from the user an answer to the question;
determining whether the answer comprises more than one parts and if yes, then:
determining other details belonging to a common group with the test detail;
determining which if any of the test detail and of the other details match the parts of the answer and considering such details as correctly answered details; and
storing for each correctly answered detail an indication of a correct answer;
and if the answer comprises no more than one part, then:
determining if the answer correctly matches the test detail; and
if yes, storing for the test detail an indication of a correct answer.

2. The method of claim 1, wherein the different parts are detected from the presence of a given delimiter.

3. The method of claim 2, wherein the given delimiter is selected from a group consisting of a comma, semicolon, space, tabulator, slash and dash.

4. The method of claim 1, further comprising maintaining a score corresponding to different details.

5. The method of claim 4, further comprising basing the determining of the detail to be tested on the score.

6. The method of claim 4, further comprising modifying the score indicative of a correct answer for each correctly answered detail only if the answer comprised only correctly answered details.

7. The method of claim 4, further comprising modifying the score indicative of a correct answer for each correctly answered detail only if the correctly answered details were provided in the answer in a correct order.

8. The method of claim 1, further comprising indicating to the user any correct answers input from the user.

9. An apparatus comprising:
a memory configured to maintain a plurality of details to be tested and to maintain group definitions which define a plurality of groups each of which groups is associated with two or more of the details;
a processor configured to determine a detail to be tested that is a test detail;
an output configured to output to a user a question to which the test detail is a correct answer;
an input configured to receive an answer to the question from the user;
the processor being further configured to:
determining whether the answer comprises more than one parts and if yes, then:
determining other details belonging to a common group with the test detail;
determining which if any of the test detail and of the other details match the parts of the answer and considering such details as correctly answered details; and
storing in the memory for each correctly answered detail an indication of a correct answer;
and if the answer comprises no more than one part, then:
determining if the answer correctly matches the test detail; and
if yes, storing for the test detail an indication of a correct answer.

10. The apparatus of claim 9, wherein the memory consists of more than one separate memory units.

11. The apparatus of claim 9, wherein the processor consists of more than one separate processing unit.

12. The apparatus of claim 9, wherein the input comprises a user interface.

13. The apparatus of claim 9, wherein the different parts are detected from the presence of a given delimiter.

14. The apparatus of claim 9, wherein the memory is configured to maintain a score corresponding to different details.

15. The apparatus of claim 14, wherein the processor is further configured to base the determining of the detail to be tested on the score.

16. The apparatus of claim 14, wherein the processor is further configured to modify the score indicative of a correct answer for each correctly answered detail only if the answer comprised only correctly answered details.

17. The apparatus of claim 14, wherein the processor is further configured to modify the score indicative of a correct answer for each correctly answered detail regardless whether the answer comprised only correctly answered details.

18. The apparatus of claim 9, wherein the processor is further configured to modify the score indicative of a correct answer for each correctly answered detail only if the correctly answered details were provided in the answer in a correct order.

19. The apparatus of claim 9, wherein the apparatus comprises a network server.

20. A computer program embodied in a physical computer readable memory and comprising computer executable program code configured to perform, when executed by a computer:
maintaining a plurality of details to be tested;
maintaining group definitions which define a plurality of groups each of which groups is associated with two or more of the details;
determining a detail to be tested that is a test detail;
presenting to a user a question to which the test detail is a correct answer;
inputting from the user an answer to the question;
determining whether the answer comprises more than one parts and if yes, then:
determining other details belonging to a common group with the test detail;
determining which if any of the test detail and of the other details match the parts of the answer and considering such details as correctly answered details; and
storing for each correctly answered detail an indication of a correct answer;
and if the answer comprises no more than one part, then:
determining if the answer correctly matches the test detail; and
if yes, storing for the test detail an indication of a correct answer.
